(19) United States
(12) Patent Application Publication
(10) Pub. No.: US 2004/0097314 A1
(43) Pub. Date: May 20, 2004

(54) Silent chain for smooth seating on sprocket teeth

(75) Inventor: Tetsuji Kotera, Nabari (JP)

Correspondence Address: BORGWARNER INC., POWERTRAIN TECHNICAL CENTER, 3800 AUTOMATION AVENUE, SUITE 100, AUBURN HILLS, MI, 48326-1782, US

(73) Assignee: BorgWarner Morse TEC Japan K.K., Nabari (JP)

(21) Appl. No.: 10/660,017

(22) Filed: Sep. 11, 2003

(30) Foreign Application Priority Data
Nov. 18, 2002 (JP) 2002-333317

(51) Int. Cl. F16H 7/06; F16G 13/04

(52) U.S. Cl. 474/213; 474/212; 474/157

(57) ABSTRACT

A silent chain for preventing chordal action and conducting a smooth wrapping around a sprocket comprising a plurality of link plates that are arranged in lateral and longitudinal directions and pivotably connected by connecting pins. Each of the link plates has a pair of teeth and pin apertures into which the connecting pins are inserted. Each of the teeth are formed of an inside flank and an outside flank. The inside flank is formed of a first circular arc on the addendum side and a second circular arc on the dedendum side. Inequalities, R₁≧2*P and R₁>>R₂, are satisfied where the radius of curvature of the first circular arc is R₁, the radius of curvature of the second circular arc is R₂, and the chain pitch is P.

### REFERENCE TO RELATED APPLICATIONS

This application claims priority from Japanese Application No. 2002-333317, filed Nov. 18, 2002 under the benefit of 35 USC §119 (a)-(d) or § 365(b). The aforementioned application is hereby incorporated by reference.

### BACKGROUND OF THE INVENTION

1. Field of the Invention

The present invention pertains to the field of silent chains. More particularly, the invention pertains to an improvement in structure to prevent chordal action and to conduct a smooth wrapping around a sprocket.

2. Description of Related Art

Silent chains have been used as a power transmission chain in automobiles, motorcycles and the like. A silent chain is generally comprised of a plurality of link plates each having a pair of teeth and pin apertures, arranged in lateral and longitudinal directions, and pivotably connected by connecting pins inserted in the pin apertures. Each of the teeth are formed of an inside flank and an outside flank. During operation of a silent chain, power is transmitted from a drive sprocket to a driven sprocket through the engagement of the inside flank and/or the outside flank with a sprocket tooth.

Chordal action, or oscillation of a chain span, occurs at the time of engagement of the chain with a sprocket. In order to prevent such a chordal action and to reduce noise, as shown in Japanese patent application laying-open publication No. 8-74940, the same inventor as the present invention, proposed a silent chain where a radius of curvature R of an inside flank of a link plate is made more than generally double the length of a chain pitch P, so that the link plate is raised through the inside flank at the time of engagement with a sprocket tooth. However, it was found through the subsequent research that as the radius of curvature of the inside flank of a link plate of the prior art silent chain becomes greater, chordal movements of the chain span decrease, but the chain span will not smoothly wrap around a sprocket tooth.

### SUMMARY OF THE INVENTION

A first aspect of the present invention is directed to a silent chain in which a plurality of link plates are interleaved in lateral and longitudinal directions and pivotably connected by connecting pins. The link plates include a pair of teeth depending therefrom and pin apertures formed therein. Each of the teeth are formed of an inside flank and an outside flank. The inside flank is formed of a first circular arc on the addendum side and a second circular arc on the dedendum side. In this case, inequalities, R₁≧2*P and R₁>>R₂ are satisfied, where a radius of curvature of the first circular arc is R₁, a radius of curvature of the second circular arc is R₂, and the chain pitch is P.

According to the first aspect of the present invention, since the radius of curvature R₁ of the first circular arc on the addendum side of the inside flank is greater than and equal to 2*P at the initial engagement of the inside flank with a sprocket tooth, the first circular arc contacts the sprocket tooth and raises the chain span between the drive sprocket and the driven sprocket. Thereby, chordal movements of a chain span may be restrained.

It is known that there exists a correlation, as shown in FIG. 8, between the radius of curvature R of an inside flank of a link plate and the amount of a chordal movement AT of the chain span. In FIG. 8, the horizontal axis shows a radius of curvature R of an inside flank. When R equals 2*P, ΔT equals 0.05 mm, which shows that the amount of chordal movement AT is remarkably decreased as compared to the case where R is smaller than 2*P. Furthermore, the radius of curvature R₂ of the second circular arc on the dedendum side of the inside flank is much smaller than a radius of curvature R₁ of the first circular arc on the addendum side of the inside flank. As a result, when a link plate wraps around a sprocket, the dedendum portion of the inside flank may be prevented from interfering with a sprocket tooth, thereby achieving a smooth wrapping of a chain span around a sprocket. In such a way, during operation, noise and oscillation performance may be improved.

In a second aspect of the present invention, inequalities, R₁≧20*P and R₁≧20*R₂ (or R₂≦R₁/20), are satisfied. As can be seen from FIG. 8, in the case where an inside flank is formed of only a first circular arc, as the radius of curvature R₁ of the first circular arc becomes greater, the chordal movement A of a chain span becomes smaller. However, such a large radius of curvature R₁ of the first circular arc may interfere with a sprocket tooth at the time of engagement with the sprocket tooth and adversely affect wrapping of a chain span around a sprocket.

In contrast, in the second aspect of the present invention, the radius of curvature R₁ of the first circular arc is made at least twenty times the chain pitch and the radius of curvature R₂ of the second circular arc is made at most one twentieth of the radius of curvature R₁ of the first circular arc. The amount of chordal movement of the chain span at the time of engagement with the sprocket may be further reduced and wrapping around the sprocket may be conducted more smoothly, thereby improving a noise and oscillation performance.

The inside flank forming each of the teeth of the link plates may be formed of a linear portion on the addendum side and a circular arc portion on the dedendum side. Alternatively, the inside flank may be formed of a first linear portion on the addendum side, a second linear portion on the dedendum with a different gradient from the first linear portion, and a small circular arc portion connecting the first and second linear portion. In either case, at the time of engagement with a sprocket, the addendum side portion of an inside flank of a link plate lifts up a chain span upwardly, thereby restraining a chordal movement of a chain and preventing the dedendum side portion of an inside flank of a link plate from interfering with a sprocket tooth. As a result, smooth wrapping around a sprocket can be achieved.

In a further aspect of the present invention, the inside and outside flanks of each of the teeth of the link plates are formed in such a way that inequalities, P₂≧P₁ and P₁′≧P₂′, are satisfied. P₁ is the pitch or distance between one outside flank and the other outside flank of a first link plate along a pitch line at the initial engagement with a sprocket tooth. P₂ is the pitch or distance between the inside flank of a second link plate and the inside flank of a third link plate along a pitch line. The second and third link plates respectively overlap with each of the teeth of the first link plate when a chain is pulled straight. P₁′ is the pitch or distance between one outside flank and the other outside flank of the first link plate on the engaging pitch line when the chain is wrapped around a sprocket and the first link plate is stationary between adjacent sprocket teeth. P₂′ is the pitch or distance between the inside flank of the second link plate and the inside flank of the third link plate on the engaging pitch line when the chain is wrapped around a sprocket and the first, second and third link plates are stationary between adjacent sprocket teeth. In this case, because P₂ is greater than or equal to P₁ on the initial engagement pitch line, the inside flank of a link plate is able to securely contact a sprocket tooth at the initial engagement. Plus, because P₁′ is greater than or equal to P₂′ on the wrapping engagement pitch line, the outside flank of a link plate is able to securely contact a sprocket tooth at the final engagement with or seating on the sprocket tooth. In such a way, at the time of engagement with a sprocket tooth, a two-stage contact occurs, whereby an engaging point moves from an inside flank to an outside flank is conducted and operational noise is reduced.

### BRIEF DESCRIPTION OF THE DRAWING

FIG. 1 is a top plan view of a portion of a silent chain according to an embodiment of the present invention.

FIG. 2 is a front elevational view of a portion of a silent chain of FIG. 1.

FIG. 3 is an enlarged front elevational view of a link plate forming a silent chain of FIG. 1.

FIG. 4 is an enlarged view of an inside flank of a link plate of FIG. 3.

FIG. 5 shows three adjacent link plates in a row in a linearly extended state of a chain for explaining pitches P₁ and P₂.

FIG. 6 shows an engaging state of a chain with a sprocket for explaining pitches P₁′ and P₂′.

FIG. 7 illustrates an engaging state of a silent chain of FIG. 1 with a sprocket.

FIG. 8 is a graph indicating an interrelation between the size of an inside flank and a chordal movement of a chain span.

### DETAILED DESCRIPTION OF THE INVENTION

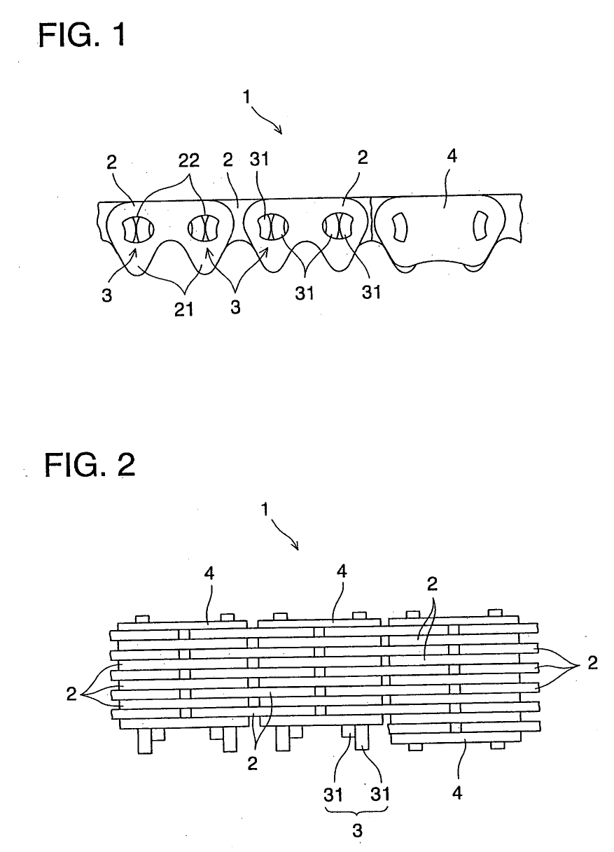

As shown in FIGS. 1 and 2, a silent chain 1 is comprised of a plurality of link plates 2 each having a pair of teeth 21 and pin apertures 22, which are interlaced in lateral and longitudinal directions and pivotably connected by connecting pins 3 inserted in the pin apertures 22. Each of the connecting pins 3 are formed of a pair of rocker pins 31. Guide links 4 are provided on the sides of the outermost link plates 2 to maintain a silent chain 1 in place on a sprocket.

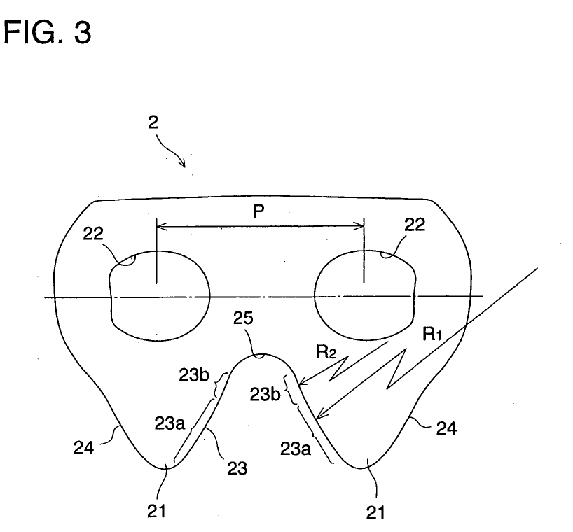

As shown in FIG. 3, a link plate 2 has a chain pitch P, which is defined as a distance between a contact point of one pair of rocker pins 31 inserted in one pin aperture 22 and a contact point of another pair of rocker pins 31 inserted in another pin aperture 22. Each of the teeth 21 are formed of an inside flank 23 and an outside flank 24. A crotch portion 25 connects adjacent inside flanks 23 of the adjacent teeth 21 with each other.

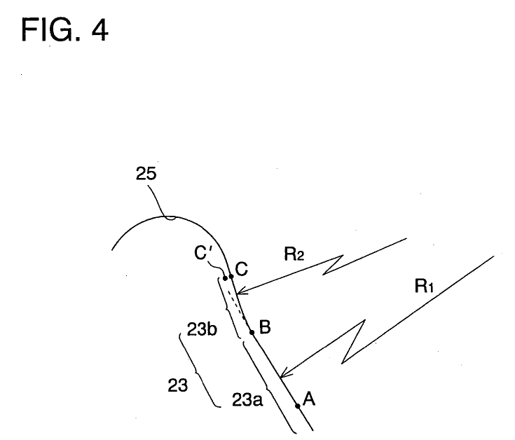

Inside flank 23 is composed of a first circular arc 23a with a radius of curvature R₁ formed on the addendum side of a tooth 21 and a second circular arc 23b of radius of curvature R₂ that is formed on the dedendum side of tooth 21, which is continuous with the first circular arc 23a. That is, the first and second circular arc 23a, 23b forming the inside flank 23 are connected at Point B, as shown in FIG. 4, but the entire inside flank 23 is formed of a continuous curve as a whole. Additionally, in FIG. 4, a dotted line shows an extended line of the first circular arc 23a. Points A, C, and C′ will be hereinafter described. Each radius of the curvatures R₁, R₂ of the first and second circular arc 23a, 23b respectively, and the pitch P satisfy the following inequalities: R₁≧2*P and R₁>>R₂. Also, more preferably, the following inequalities are satisfied: R₁≧20*P and R₁≧20*R₂.

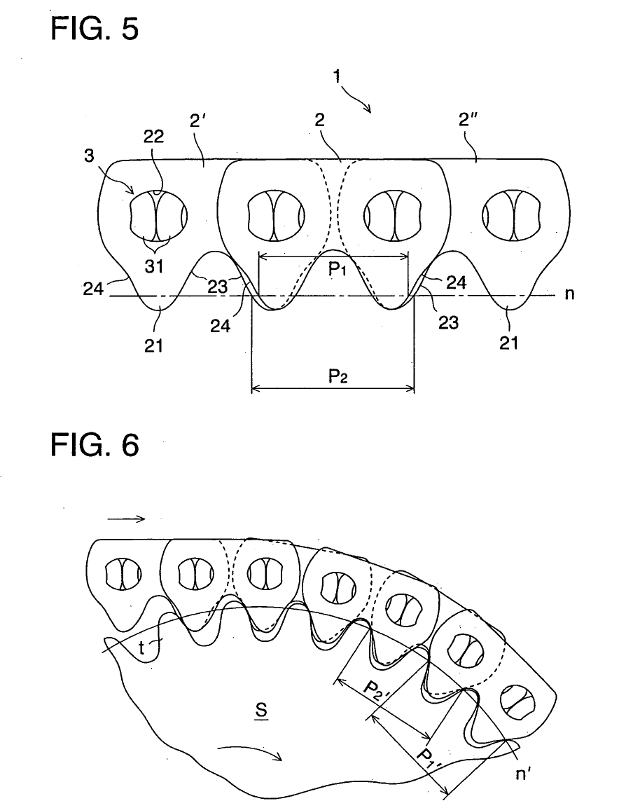

The relative plain configurations of the inside and outside flank 23, 24 forming each tooth 21 of a link plates 2 will be explained using FIGS. 5 and 6. FIG. 5 shows a state where a silent chain 1 is pulled straight, and FIG. 6 shows a state where the silent chain 1 is wrapped around a sprocket S. As shown in FIG. 5, pitches P₁ and P₂ satisfy an inequality, P₂≧P₁, where P₁ is the pitch or distance between the oppositely disposed outside flanks 24 and 24 of a link plate 2 along a pitch line n at the initial engagement with a sprocket tooth t, and P₂ is the pitch or distance between the inside flank 23 of a link plate 2′ and the inside flank 23 of a link plate 2″ along a pitch line n, the link plate 2′ and the link plate 2″ respectively overlapping with each of the teeth 21 of the link plate 2 when a chain 1 is pulled straight.

As shown in FIG. 6, pitches P₁′ P₂′ satisfy an inequality, P₁′≧P₂′, where P₁′ is a pitch or distance between the oppositely disposed outside flanks 24 and 24 of the link plate 2 on the engaging pitch line n′ when the chain 1 is wrapped around a sprocket S and the link plate 2 is stationary between adjacent sprocket teeth t. P₂′ is the pitch or distance between the inside flank 23 of the link plate 2′ and the inside flank 23 of the link plate 2″ on the engaging pitch line n′ when the chain 1 is wrapped around the sprocket S and the link plates 2, 2′ and 2″ are stationary between adjacent sprocket teeth t.

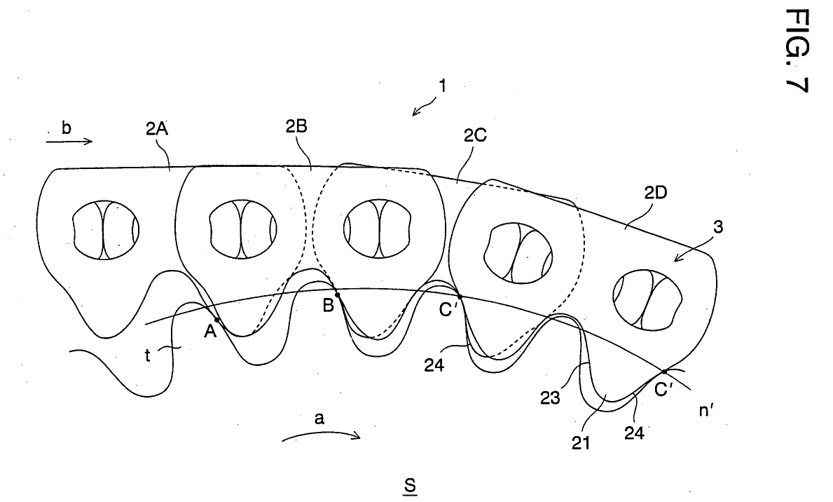

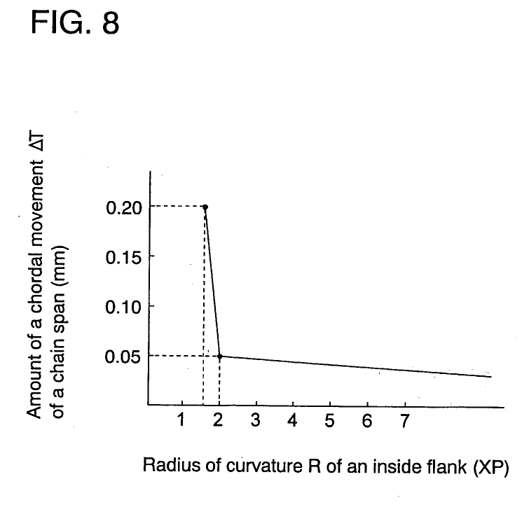

Next, engagement of the above-mentioned silent chain 1 with a sprocket will be described using FIG. 7. In FIG. 7, an arrow mark “a” indicates the rotational direction of a sprocket S, and an arrow mark “b” indicates the running direction of a silent chain 1. Reference numerals 2A, 2B, 2C, and 2D indicate link plates that are located in a row from the retarding side of the engagement to the leading side thereof, respectively.

At the time of initial engagement with the sprocket S, Point A (FIG. 4) on the first circular arc 23a on the addendum side of the inside flank 23 of the link plate 2A contacts a sprocket tooth t. When the engagement proceeds and the link plate 2A moves to the position of a link plate 2B, the engagement point with a sprocket tooth t is transferred to Point B from Point A along the inside flank 23. Point B, shown in FIG. 4, is a terminal point of the first circular arc 23a, or an initial point of the second circular arc 23b.

When the engagement point on the inside flank 23 of the link plate 2A travels from Point A to Point B along the first circular arc 23a, the link plate 2A interferes with a sprocket tooth t and is raised upwardly by the sprocket tooth t, thereby lifting a chord or a chain span upwardly. When the engagement further proceeds and the link plate 2A moves to the position of link plate 2C, the sprocket tooth t engages, at Point C′, with the outside flank 24 of the link plate 2D located on the leading side of the engagement and seats on the sprocket tooth t. Point C′ is, shown in FIG. 4, located slightly away from Point C, or a terminal point on the second circular arc 23b on the dedendum side of the inside flank 23. That is, while the engagement point with the sprocket tooth t travels from the terminal point B on the first circular arc 23a of the inside flank 23 of the link plate 2B to Point C′ on the outside flank 24 of the link plate 2C, the link plate 2B finishes lifting up a chain span at Point B and at the same time, starts wrapping around the sprocket S, and thereafter, at Point C′, finishes wrapping around the sprocket S and at the same time, finishes engaging to seat on the sprocket tooth t. Therefore, a curved surface portion AB formed of the first circular arc 23a on the inside flank 23 of a link plate participates in lifting up a chain span and a curved surface portion BC formed of the second circular arc 23b participates in wrapping around a sprocket.

According to this embodiment, since the radius of curvature R₁ of the first circular arc 23a on the addendum side of the inside flank 23 is greater than or equal to 2*P, at the initial engagement of the inside flank with a sprocket S, the first circular arc 23a contacts the sprocket tooth t and raises a chain span upwardly. Thereby, chordal movements of a chain span can be restrained. Radius of curvature R₂ of the second circular arc 23b on the dedendum side of the inside flank 23 is much smaller than the radius of curvature R₁ of the first circular arc 23a on the addendum side of the inside flank 23. As a result, when a link plate 2 wraps around a sprocket S, the dedendum portion of the inside flank 23 can be prevented from interfering with a sprocket tooth t, thereby achieving a smooth wrapping around a sprocket S. In such a way, during operation, noise and oscillation performance can be improved.

When inequalities, R₁≧20*P and R₁≧20*R₂, are satisfied, the amount of chordal movement of a chain span at the time of engagement with a sprocket S can be further reduced and wrapping around the sprocket can be conducted more smoothly, thereby further improving a noise and oscillation performance. In this case, P₂ is greater than or equal to P₁ on the initial engagement pitch line n, which enables the inside flank 23 of a link plate 2 to securely contact a sprocket tooth t at the initial engagement with a sprocket tooth t. Also, P₁′ is greater than or equal to P₂′ on the wrapping engagement pitch line n′, which enables the outside flank 24 of a link plate 2 to securely contact a sprocket tooth t at the final engagement with or seating on the tooth t. In such a way, at the time of engagement with a sprocket tooth t a two-stage contact occurs whereby an engaging point moves from an inside flank 23 to an outside flank 24 is conducted, operational noise is reduced.

In addition, according to the above-mentioned embodiment, the inside flank 23 of a link plate 2 is formed of a first circular arc 23a of a relatively greater radius of curvature on the addendum side and a second circular arc 23b of a relatively smaller radius of curvature on the dedendum side, but the present invention is not limited to this example. The addendum side portion of the inside flank may be formed of a linear portion and a circular arc portion may be formed on the dedendum side that is continuous with the linear portion. Alternatively, the inside flank may be formed of a first linear portion on the addendum side, a second linear portion on the dedendum side with a different gradient from the first linear portion, and a small circular arc portion connecting the first and second linear portion. In this case, the gradient of the second linear portion is measured from the pitch line direction is greater than the gradient of the first linear portion measured from the pitch line direction. In either case, at the time of initial engagement with a sprocket, the addendum side portion of an inside flank of a link plate lifts the chain span upwardly, thereby restraining a chordal movement of a chain and preventing a dedendum side portion of an inside flank of a link plate from interfering with a sprocket tooth. As a result, smooth wrapping around a sprocket can be achieved.

Additionally, in the above-mentioned embodiment, a rocker joint-type silent chain was shown as an example of a silent chain, but the present invention may be applied to a silent chain where round pins are utilized to connect the link plates.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A silent chain having reduced chordal action and a smooth wrapping around a sprocket comprising:
a plurality of interlaced link plates, each link plate having a pitch P and comprising:
a pair of teeth, each having an inside flank and an outside flank,
the inside flank of each tooth comprising a first circular arc with a radius of curvature R₁ on an addendum side and a second circular arc with a radius of curvature R₂ on a dedendum side; and
wherein inequalities, R₁≧2*P and R₁>>R₂, are satisfied.

2. The silent chain of claim 1, wherein inequalities, R₁≧20*P and R₁≧20*R₂, are satisfied.

3. The silent chain of claim 1, wherein inequality P₂≧P₁ is satisfied, where P₁ is the pitch between the outside flank and the other outside flank along pitch line of a first link plate at initial engagement of the link plate with a sprocket tooth, and P₂ is the pitch between the inside flank of a second link plate and the inside flank of a third adjacent link plate along the pitch line.

4. The silent chain of claim 3, wherein when the chain is pulled straight, the second link plate and the third link plate overlap the teeth of the first link plate.

5. The silent chain of claim 1, wherein inequality P₁′≧P₂′ is satisfied, where P₁′ is the pitch between the outside flank and the other outside flank along pitch line of the first link plate at final engagement of the link plate with a sprocket tooth and P₂′ is the pitch between the inside flank of the second link plate and the inside flank of the third link plate along the pitch line.

6. The silent chain of claim 5, wherein the first link plate is stationary between adjacent sprocket teeth when the chain is wrapped around the sprocket.

7. The silent chain of claim 5, wherein the first link plate, the second link plate, and the third link plate are stationary between adjacent sprocket teeth.

8. The silent chain of claim 1, wherein the inside flank comprises a linear portion on the addendum side and a circular arc portion on the dedendum side.

9. The silent chain of claim 1, wherein the inside flank comprises a first linear portion on the addendum side and a second linear portion on the dedendum side with a circular arc portion connecting the first linear portion to the second linear portion.

10. The silent chain of claim 9, wherein the second linear portion has a different gradient then the first linear portion.
